(19) United States
(12) Patent Application Publication
(10) Pub. No.: US 2023/0396496 A1
(43) Pub. Date: Dec. 7, 2023

(54) AUTOMATED RULE GENERATION FOR NETWORK FUNCTIONS

(71) Applicant: AT&T Intellectual Property I, L.P., Atlanta, GA (US)

(72) Inventors: Jay Gabin, Dexter, ME (US); Susan Kennedy, Newport News, VA (US); Stephanie Parlamas, Colts Neck, NJ (US)

(21) Appl. No.: 17/805,083

(22) Filed: Jun. 2, 2022

(51) Int. Cl. H04L 41/084; H04W 24/02; H04L 41/0894; H04L 41/0893

(52) U.S. Cl. CPC H04L 41/084; H04W 24/02; H04L 41/0894; H04L 41/0893

(57) ABSTRACT

Techniques for automated generation of rules associated with network functions are presented. A template generator component can generate, for each network function (NF), a rule template associated with the NF based on rule format parameters associated with an application or user, wherein the rule template can comprise a group of rule elements and one or more tags associated with one or more variables associated with the NF. A rule generator component can, for each desired event associated with each NF, automatically generate a rule based on the rule template and event-related data of a data file received from a user. As part of rule generation, for each tag, the rule generator component can identify the tag in the rule template, based on a tag indicator indicative of the tag, and replace the tag in the rule template with an item of the event-related data that relates to the variable.

### TECHNICAL FIELD

The subject disclosure relates generally to communication networks, e.g., to automated rule generation for network functions.

### BACKGROUND

A communication network, such as a fifth generation (5G) or other wireless communication network, and/or a wireline communication network, can employ various network functions that perform respective network operations, and can interact or communicate with other network functions, nodes, elements, or components of the communication network. The network functions can be monitored using, for example, a fault monitoring and alert application (e.g., ElastAlert or other type of fault monitoring and alert application). The fault monitoring and alert application can employ an application framework that can monitor the network functions, which can generate events relating to operation of the network functions, and the application framework can process event information relating to the events that it receives from the network functions, determine whether anomalies or other data patterns of interest are occurring in the communication network, determine whether an alert is to be generated with regard to an event, and/or determine whether certain event information is to be forwarded to another network function, node, element, or component of the communication network. The application framework can utilize or execute rules that can govern how the event information relating to the events is to be processed.

The above-described description is merely intended to provide a contextual overview relating to communication networks, and is not intended to be exhaustive.

### BRIEF DESCRIPTION OF THE DRAWINGS

FIG. 1 depicts a block diagram of an example, non-limiting system that can desirably determine, generate, and manage rule templates and rules associated with network functions, in accordance with various aspects and embodiments of the disclosed subject matter.

FIG. 2 depicts a block diagram of an example, non-limiting rule generation management component (RGMC), in accordance with various aspects and embodiments of the disclosed subject matter.

FIG. 3 illustrates a block diagram of a non-limiting example rule template and rule generation process, in accordance with various aspects and embodiments of the disclosed subject matter.

FIG. 4 illustrates a diagram of an example, non-limiting rule template that can be utilized to generate rules associated with one or more network functions, for use with a desired application, in accordance with various aspects and embodiments of the disclosed subject matter.

FIG. 5 depicts a diagram of an example, non-limiting rule that can be determined and generated based at least in part on the rule template and data obtained from a data file, for use with a desired application, in accordance with various aspects and embodiments of the disclosed subject matter.

FIG. 6 presents a diagram of a portion of the data file, in accordance with various aspects and embodiments of the disclosed subject matter.

FIG. 7 depicts a diagram of another example, non-limiting rule that can be determined and generated based at least in part on a rule template and data obtained from a data file, for use with a desired application, in accordance with various aspects and embodiments of the disclosed subject matter.

FIG. 8 presents a diagram of a portion of the data file, in accordance with various aspects and embodiments of the disclosed subject matter.

FIG. 9 illustrates a flow diagram of an example, non-limiting method that can desirably determine rule templates and rules associated with network functions, in accordance with various aspects and embodiments of the disclosed subject matter.

FIG. 10 depicts illustrates a flow diagram of another example, non-limiting method that can desirably determine rule templates and rules associated with network functions, in accordance with various aspects and embodiments of the disclosed subject matter.

FIG. 11 illustrates an example block diagram of an example computing environment in which the various embodiments of the embodiments described herein can be implemented.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular network environment or standard).

A fault monitoring and alert application (e.g., ElastAlert or other type of fault monitoring and alert application) can employ an application framework that can monitor network functions of a communication network (e.g., 5G or other wireless communication network, and/or a wireline communication network), wherein the network functions can generate events relating to operation of the network functions. The application framework can process event information relating to the events that it receives from the network functions, determine whether anomalies or other data patterns of interest are occurring in the communication network, determine whether an alert is to be generated with regard to an event, and/or determine whether certain event information is to be forwarded to another network function, node, element, or component of the communication network (e.g., for further processing or action). The application framework can utilize or execute rules that can govern how the event information relating to the events is to be processed.

There can be dozens, hundreds, or even thousands of rules for each network function, and there can be dozens or even hundreds of network functions associated with a communication network. Each event for which alarming is configured can have its own rule file, which can have some event specific information that can be within a vendor-specific rule file format.

Existing approaches to creating the rules can involve a user manually creating each rule file. It can be undesirably cumbersome, time consuming, and inefficient to manually create each rule file independently, particularly since there can be many rules for each network function, and many network functions associated with the communication network. Also, manually creating rule files can be error prone, resulting in an undesirably number of errors in the manual process. Further, if the rule file format has to be changed and/or if the data provided by a vendor to create the rules is changed, the user has to manually create new rule files for all or at least some of the many rules.

The disclosed subject matter can overcome these and other problems associated with creating rule files for network functions associated with a communication network.

To that end, techniques, methods, and systems for automated generation of rules associated with network functions are presented. The disclosed subject matter can comprise a rule generation management component (RGMC) that can manage and/or perform various operations and processing for the determination and generation of rules associated with network functions. The RGMC can comprise a template generator component that, for one or more network functions, can generate a rule template associated with the one or more network functions based at least in part on rule format parameters and/or a group of rule elements that can be associated with an application (e.g., ElastAlert or other desired application) and/or a user (e.g., communication network provider, operator, developer, engineer, or technician; vendor; or other user). The RGMC can receive information relating to the rule format parameters and/or the group of rule elements from the user, the application, and/or another data source. Each rule template can comprise the group of rule elements and one or more tags associated with one or more variables (e.g., parameters) associated with the network function.

The RGMC also can comprise a rule generator component that, for each network function and for each desired event associated with each network function, can determine and generate (e.g., automatically determine and generate) a rule (e.g., a rule file comprising a rule), based at least in part on the rule template and event-related data of a data file received from a user (e.g., vendor or other user), to generate a group of rules associated with the network function. As part of rule generation, for each tag, the rule generator component can identify the tag in the rule template, based on a tag indicator indicative of the tag, and replace the tag in the rule template with an item of the event-related data that relates to the variable. For each network function, utilizing the rule template, the rule generator component can determine and generate a group of rules associated with the network function and the desired events. The RGMC can provide the group of rules as an output to facilitate installation of the group of rules in the application.

If updated or new data of an updated or new data file is received by the RGMC from a user (e.g., vendor or other user), the rule generator component can determine and generate updated or new rules based at least in part on the results of an analysis of the rule template and updated or new data of the updated or new data file. If updated or new rule format parameters, rule elements, and/or rule-related information are received by the RGMC from a user (e.g., communication network provider, operator, developer, engineer, or technician; vendor; or other user) and/or application, the template generator component can determine and generate an updated or new rule template based at least in part on the updated or new rule format parameters, rule elements, and/or rule-related information. The rule generator component can determine and generate updated or new rules based at least in part on the results of an analysis of the updated or new rule template and the data from the data file (or updated or new data from an updated or new data file, if there is an updated or new data file).

The disclosed subject matter, employing the RGMC, can desirably (e.g., automatically, accurately, efficiently, and/or optimally) determine and generate rule templates, determine and generate rules associated with network functions or other network elements, update rule templates, and determine and generate updated rules in response to changes to the rule templates or the event-related data. The RGMC can reduce the amount of time utilized to generate the rules, reduce (e.g., mitigate or minimize) error associated with generating rules, and reduce the amount of resources used to generate rules, as compared to existing techniques for rule generation. The RGMC also can free up manpower to enable employees to do other work tasks while the RGMC automatically generates the rules.

These and other aspects and embodiments of the disclosed subject matter will now be described with respect to the drawings.

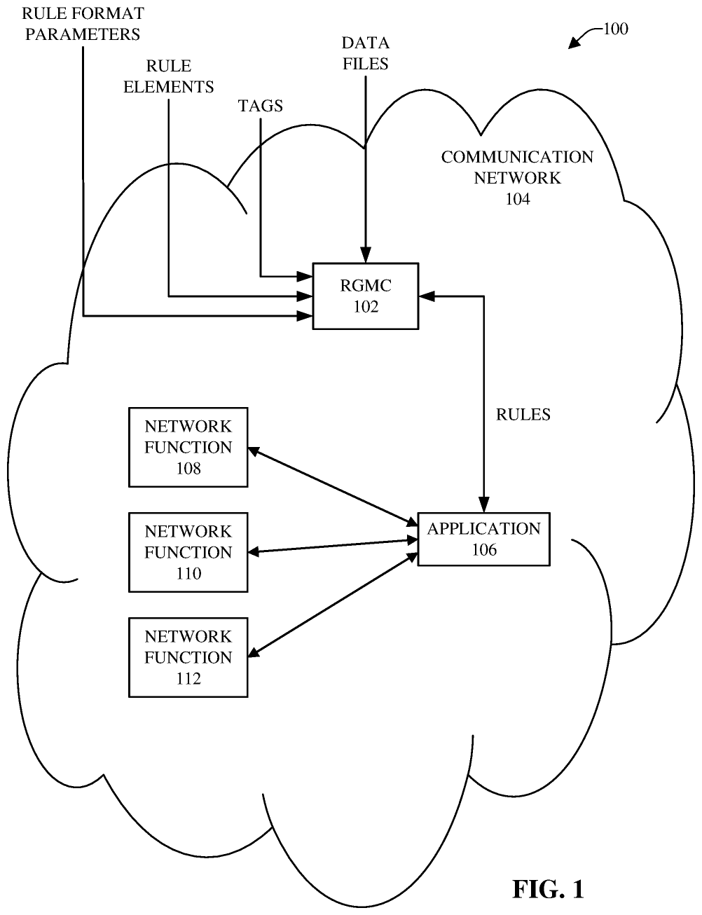

FIG. 1 depicts a block diagram of an example, non-limiting system 100 that can desirably (e.g., automatically, accurately, efficiently, and/or optimally) determine, generate, and manage rule templates and rules associated with network functions, in accordance with various aspects and embodiments of the disclosed subject matter. The system 100 can comprise a rule generator management component (RGMC) 102 that can determine and generate (e.g., automatically determine and generate) and/or manage the determination and generation of rule templates and rules (e.g., using the rule templates) associated with network functions or other network elements of a communication network 104 (e.g., a wireline communication network, a wireless or cellular communication network, or other type of communication network) and associated with an application 106 (e.g., ElastAlert or other desired application). In some embodiments, the communication network 104 can be or can comprise a packet-based network that can communicate data (e.g., packets of data) using a desired communication protocol (e.g., mobility protocols, Internet protocol (IP), IP version 4 (IPv4), mobile IPv4, IP version 6 (IPv6), mobile IPv6, transmission control protocol (TCP), user datagram protocol (UDP), or other desired communication protocol).

The communication network 104 can comprise various network functions, such as network function 108, network function 110, and network function 112, and other network elements (e.g., network components, devices, or equipment) that can operate to enable communication of information between communication devices (not shown) associated with (e.g., communicatively connected to) the communication network 104. In accordance with various embodiments, a network function (e.g., 108, 110, or 112) can be a physical network function (PNF), a virtualized network function (VNF), or a cloud-native or containerized network function (CNF) (e.g., a containerized virtual network function). PNFs can include, for example, physical routers, switches, terminal servers, and/or other types of physical network functions or components. In certain embodiments, the network functions (e.g., 108, 110, and/or 112) can comprise network functions associated with a core network (e.g., mobility or wireless core network), such as, for example, a short message service function (SMSF), user plane function (UPF), core access and mobility management function (AMF), authentication server function (AUSF), session management function (SMF), network slice selection function (NSSF), network exposure function (NEF), network function repository function (NRF), policy control function (PCF), unified data management (UDM), application function (AF), data network (DN), or other desired type of function.

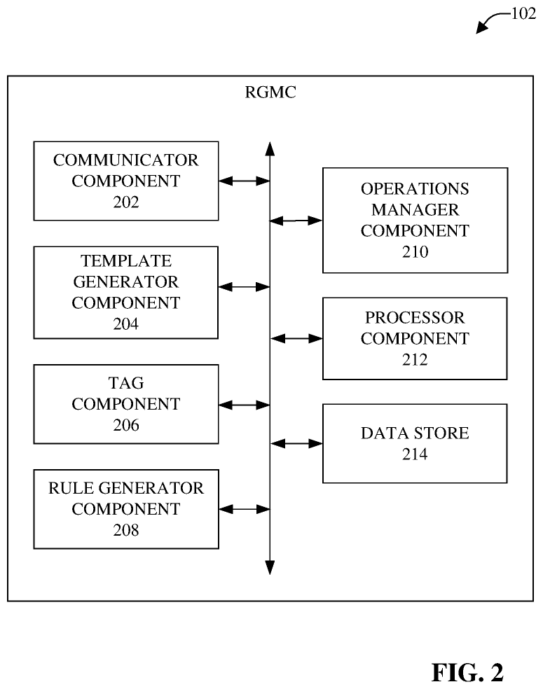

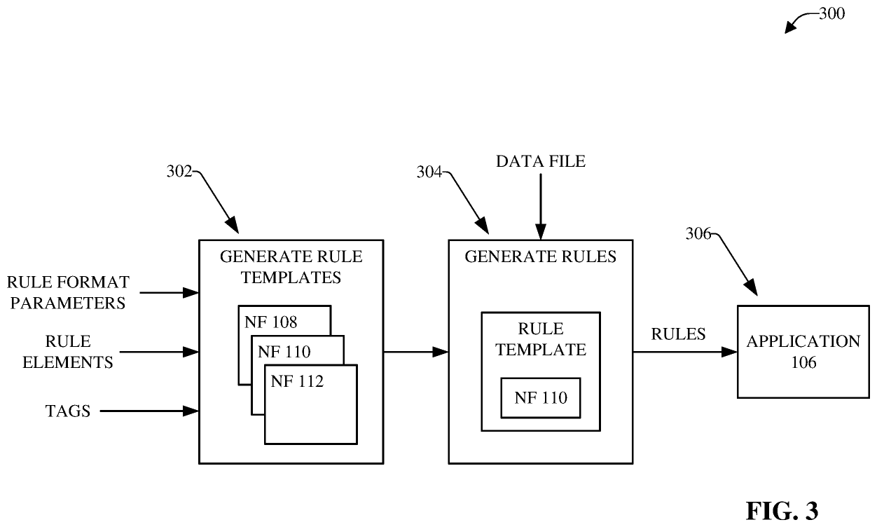

Turning to FIGS. 2 and 3 (along with FIG. 1), FIG. 2 depicts a block diagram of the RGMC 102, and FIG. 3 illustrates a block diagram of a non-limiting example rule template and rule generation process 300, in accordance with various aspects and embodiments of the disclosed subject matter. The RGMC 102 can comprise a communicator component 202 that can receive or transmit information via one or more interfaces, such as described herein. For instance, the communicator component 202 can receive information relating to rule format parameters and/or a group of rule elements associated with the application 106 and/or a user (e.g., communication network provider, operator, developer, engineer, or technician; vendor; or other user) from the application, the user (e.g., via an interface or communication device), and/or another data source. The communicator component 202 also can receive information relating to one or more desired tags from the user, wherein the one or more tags can be associated with one or more variables (e.g., parameters) associated with a network function(s).

The RGMC 102 also can comprise a template generator component 204 that can determine and generate rule templates that can be utilized to generate desired rules associated with network functions. The rules can be utilized (e.g., executed) by the application 106 to facilitate monitoring operations of the network functions (e.g., network function (NF) 108, NF 110, NF 112) and the communication network 104 overall, generating alerts when certain conditions are satisfied (e.g., met) during events, providing information relating to events (e.g., when certain conditions are satisfied or occur), and/or performing other desired tasks or actions. In some embodiments, with regard to one or more network functions (e.g., 108, 110, and/or 112), the template generator component 204 can determine and generate a rule template associated with the one or more network functions based at least in part on the rule format parameters and/or the group of rule elements associated with the application 106 and/or the user, and/or the one or more tags, as indicated at reference 302 of the example rule template and rule generation process 300 of FIG. 3. Each rule template can comprise the group of rule elements and the one or more tags associated with one or more variables (e.g., parameters) associated with the network function. The rule format parameters can indicate or specify the format, arrangement, or structure of rule elements of the group of rule elements in relation to each other in the rule template. The rule elements can comprise or relate to various types of data (e.g., network function-related data), variables (e.g., parameters), and/or conditions that can be desired in a rule. The rule template can resemble rules associated with the application 106, and can be in the desired rule format associated with the application 106, except that the rule template itself is not a valid rule, as the rule template can comprise the one or more tags, which will have to be replaced with appropriate items of data to create the desired rules, such as described herein. The template generator component 204 can determine and generate the rule template(s) in advance of the desire (e.g., want or need) to generate rules associated with the network functions.

The group of rule elements can comprise, for example, a name element, type element, index element, timeframe element, realert element, filter element, query element, condition element, query key element, payload element, and/or another desired element. The name element can relate to the rule name and/or network function name. The type element can relate to, for example, the type of event. The index element can relate to the index where network function-related information relating to the network function can be located or from which such network function-related information can be retrieved. The timeframe element can indicate or specify an amount of time (e.g., time window or look-back time window) that the application 106 executing the rule is to look back or consider with regard to events under consideration by the rule (e.g., events associated with the network function or a portion of the network function). The realert element can indicate or specify an amount of time that the application 106 is to wait before communicating a realert message regarding a particular event or a condition that has been satisfied (e.g., met or breached). The filter element can filter network function-related information based on one or more queries and/or conditions. The query element can comprise or relate to one or more queries or query strings relating to the network function. The condition element can relate to one or more conditions or particular types of events that can be associated with, or that may occur with regard to, the network function. The query key element can relate to one or more keywords that can be associated with the one or more queries and/or conditions. The payload element can comprise or indicate various types of network function-related information that is to be included in a data payload that can be forwarded to another network element, network node, network system, or network subsystem (e.g., if a condition associated with the rule has been satisfied).

The RGMC 102 also can include a tag component 206 that can insert, embed, or incorporate the one or more tags in the rule template. The tag component 206 can insert respective (e.g., different) tags in respective rule templates. For instance, the tag component 206 can determine and generate a first group of tags for a first rule template, and insert the tags of the first group of tags in the appropriate places in the first rule template; and can determine and generate a second group of tags for a second rule template, and insert the tags of the second group of tags in the appropriate places in the second rule template. The tag component 206 can structure the tags in a defined tag format that can enable a rule generator component 208 to identify a tag in the rule template, distinguish the tag from other information (e.g., rule elements and other information) in the rule template, and replace the tags with corresponding items of data obtained from a data file, when the rule generator component 208 is generating the rules associated with the one or more network functions (e.g., 108, 110, and/or 112). A tag can comprise an indicator (e.g., brace-brace at each end of the tag ({{TAG NAME}} or {{SITE-NAME}}), or other desired type of indicator), which can indicate that the tag is a tag, a tag name, and/or other desired tag-related information, wherein the tag name can indicate the variable to which the tag pertains, what type of tag it is (e.g., what type of variable is part of the tag), what type of data the tag is associated with, and/or what type of data to retrieve from the data file (e.g., data file received from or otherwise associated with a vendor).

Each data file can be a network function-specific data file, which can be provided to the RGMC 102 by a user (e.g., a vendor or other user). The data file can comprise respective items of data that can be inserted (e.g., by the rule generator component 208) in respective places (e.g., respective fields, cells, or locations) and/or associated with respective rule elements in respective rules associated with the one or more network functions (e.g., 108, 110, and/or 112), such as described herein. In certain embodiments, the items of the data in the data file (e.g., Microsoft Excel or other type of spreadsheet file, a ColdFusion component (CFC) file, a JavaScript Object Notation (JSON) file, or other type of structured data file) can be arranged in a structured format (e.g., a defined spreadsheet format, a CFC format, a JSON format, or other structured format) in the data file. For example, the data file can be a spreadsheet that can be in a defined spreadsheet format and can comprise rows and columns in which the items of data can be placed (e.g., items of data can be inserted in respective cells, places, or locations that can be associated with the respective rows and respective columns of the spreadsheet). In other embodiments, the items of data can be in an unstructured format in the data file (e.g., textual data in a text format). In some embodiments, the tag component 206 can determine or identify the respective types of data (e.g., network function name; network element or component name; severity level; or other data type) of the respective items of data in a data file based at least in part on an analysis of the data file and/or one or more keywords.

In some embodiments, the tag component 206 can map or associate the respective items of data, or respective columns associated with the respective items of data, to or with respective tags in the rule template. For example, if a first column of a data file (e.g., a spreadsheet) comprises respective network element names of respective network elements in respective rows of the data file, and if a first tag of a rule template represents or is associated with a first variable that can be network element names, the tag component 206 can map the first tag to the first column of the data file, and/or to the respective items of data (e.g., respective network element names) of the first column of the data file. Also, if a second column of the data file comprises respective events (e.g., severity levels, or other type of event or condition) that can be associated with the respective network elements in respective rows of the data file, and if a second tag of the rule template represents or is associated with a second variable that can relate to events, the tag component 206 can map the second tag to the second column of the data file, and/or to the respective items of data (e.g., respective event-related items of data) of the second column of the data file.

With regard to the one or more network functions, or other network elements, and with regard to respective events or conditions associated with each network function (e.g., NF 110), for which rules can be desired, the rule generator component 208 can determine and generate (e.g., automatically determine and generate) respective rules (e.g., respective rule files comprising respective rules) of a group of rules based at least in part on the results of analyzing the rule template and the items of data (e.g., event-related data and other data) of the data file received from a user (e.g., vendor or other user), as indicated at reference numeral 304 of the example rule template and rule generation process 300 of FIG. 3. As part of the analysis and the rule generation, for each respective tag of the one or more tags in the rule template, the rule generator component 208 can identify the respective tag in the rule template, based at least in part on a respective tag indicator indicative of the respective tag, and replace the respective tag in the rule template with a corresponding (e.g., mapped or associated) item of data in the data file that relates to the respective variable associated with the respective tag. To continue with the example above, if the data file is the spreadsheet, the rule generator component 208 can replace the first tag representative of the first variable relating to network element name in the rule template with a first network element name obtained from the first row of the first column of the data file, and can replace the second tag representative of the second variable relating to events in the rule template with a first event obtained from the first row of the second column of the data file, to generate a first rule; can replace the first tag representative of the first variable in the rule template with a second network element name obtained from the second row of the first column of the data file, and can replace the second tag representative of the second variable in the rule template with a second event obtained from the second row of the second column of the data file, to generate a second rule; can replace the first tag representative of the first variable in the rule template with a third network element name obtained from the third row of the first column of the data file, and can replace the second tag representative of the second variable in the rule template with a third event obtained from the third row of the second column of the data file, to generate a third rule; and can proceed to generate one or more other rules in a similar manner based at least in part on the items of data in the data file.

The rule files comprising the rules can be in a desired file format, such as, for example, a yaml ain′t markup language (yaml) format or other desired structured file format (e.g., other desired structured data serialization format). The RGMC 102 can utilize a desired programming language, such as, for example, Node.js (JavaScript), Java, Python, or other desired programming language, to code the programming that can be utilized to generate rule templates and generate rules utilizing the rule templates.

The RGMC 102 (e.g., via the communicator component 202 and desired interface) can provide the group of rules associated with each network function (e.g., 108, 110, and/or 112) as an output to facilitate installation (e.g., uploading) of the group of rules in the application 106, wherein the group of rules can be installed in the application 106, as indicated at reference numeral 306 of the example rule template and rule generation process 300 of FIG. 3. The application 106 can execute the group of rules to desirably monitor the communication network 104 (e.g., monitor the network functions and other network elements of the communication network 104), identify (e.g., detect) events, process information relating to the network functions, other network elements, and/or events, and communicate desired information (e.g., alerts or other desired information) to appropriate network elements, in accordance with the group of rules.

If updated or new data of an updated or new data file is received by the RGMC 102 (e.g., via the communicator component 202) from a user (e.g., vendor or other user), the rule generator component 208 can determine and generate updated or new rules based at least in part on the results of an analysis of the rule template and the updated or new data file. For instance, the rule generator component 208 can identify the one or more respective tags in the rule template, and can replace the one or more respective tags in the rule template with one or more respective items of data obtained from the analysis of the updated or new data file, in a same or similar manner as described herein with regard to generating the group of rules.

In some embodiments, if updated or new rule format parameters, rule elements, and/or rule-related information are received by the RGMC 102 from a user (e.g., communication network provider, operator, developer, engineer, or technician; vendor; or other user) and/or application, the template generator component 204 can determine and generate an updated or new rule template based at least in part on the updated or new rule format parameters, rule elements, and/or rule-related information. The rule generator component 208 can determine and generate updated or new rules, based at least in part on the results of an analysis of the updated or new rule template and the items of data from the data file (or updated or new items of data from an updated or new data file, if there is an updated or new data file), in a same or similar manner as described herein with regard to generating the group of rules.

These and other aspects and embodiments of the disclosed subject matter will be described or further described with respect to the other drawings, as well as with respect to FIGS. 1-3.

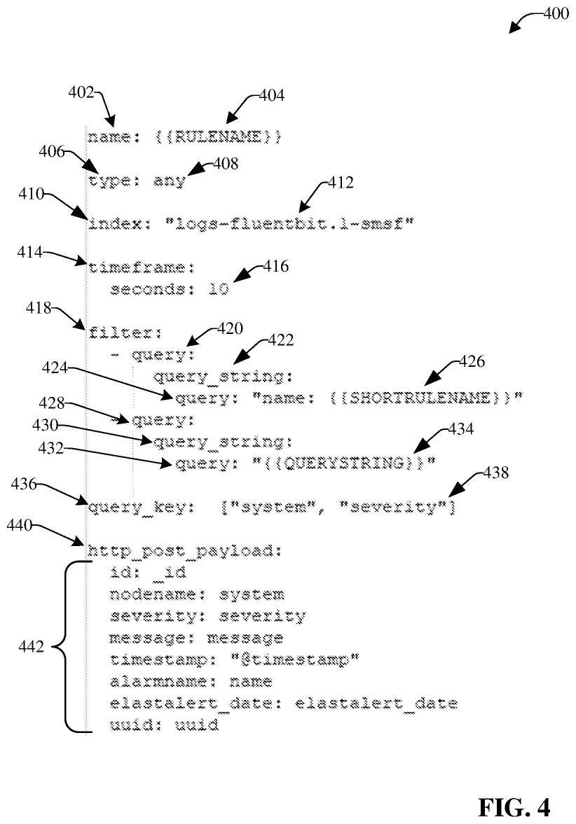

Referring to FIG. 4 (along with FIGS. 1-3), FIG. 4 illustrates a diagram of an example, non-limiting rule template 400 that can be utilized to generate rules associated with one or more network functions, for use with a desired application, in accordance with various aspects and embodiments of the disclosed subject matter. The template generator component 204 can determine and generate the rule template 400 based at least in part on rule format parameters, a group of rule elements, and/or tags, which can be associated with the application 106 and/or a user (e.g., communication network provider, operator, developer, engineer, or technician; vendor; or other user), and which can be provided to the RGMC 102 by the user, the application 106, and/or another data source. In some embodiments, the user can utilize, manipulate, or control the template generator component 204 to generate the rule template 400.

Based at least in part on the rule format parameters, the template generator component 204 can arrange respective rule elements, tags relating to variables, and associated information (e.g., parameters that can be fixed across a group of rules, payload data, or other desired information) in respective places in relation to each other in the rule template 400. For example, based at least in part on the rule format parameters, tags, and group of rule elements, at a first subset of locations in the rule template 400, the template generator component 204 can insert a name element 402 (e.g., name) relating to the name of a network function and/or an associated particular network element, and, adjacent to the name element 402, can insert a first tag 404 (e.g., {{RULENAME}}), which can be associated with a first variable (e.g., first parameter) that can represent or relate to a rule name of a rule being generated.

Based at least in part on the rule format parameters, tags, and group of rule elements, at a second subset of locations in the rule template 400, the template generator component 204 can insert a type element 406 and type-related information 408, such as, in this example, “any,” adjacent to the type element 406. It is noted that, in another rule template, the type-related information can (or may not) be different. Based at least in part on the rule format parameters, tags, and group of rule elements, at a third subset of locations in the rule template 400, the template generator component 204 can insert an index element 410 and index-related information 412, such as, in this example, “logs-fluentbit.1-smsf,” adjacent to the index element 410. It is noted that, in another rule template, the index-related information can (or may not) be different. Based at least in part on the rule format parameters, tags, and group of rule elements, at a fourth subset of locations in the rule template 400, the template generator component 204 can insert a timeframe element 414, comprising “timeframe” and “seconds,” and associated time frame-related information 416, such as, in this example, “10,” adjacent to the timeframe element 414, which can indicate the time frame (e.g., the last 10 seconds) under consideration by the application 106 to look for events that may have occurred and/or a number of events that may have occurred during that time frame. It is noted that, in another rule template, the time frame-related information can (or may not) be different (e.g., an amount of time greater or less than 10 seconds can be utilized, as desired by a user).

Also, based at least in part on the rule format parameters, tags, and group of rule elements, at a fifth subset of locations in the rule template 400, the template generator component 204 can insert a filter element 418 (e.g., “filter”) that can comprise or be associated with one or more desired query elements, query string elements, and/or query key elements. For instance, in the example rule template 400, the template generator component 204 can insert a query element 420 comprising query string 422, with the associated query 424, and, adjacent to the query 424, can insert a second tag 426 (e.g., {{SHORTRULENAME}}), which can be associated with a second variable (e.g., second parameter) that can represent or relate to a short rule name of a rule being generated. A short rule name can relate to or be the name of a particular network element (e.g., central processing unit (CPU)) associated with a network function, for example. Also, in the example rule template 400, the template generator component 204 can insert another query element 428 comprising query string 430, with associated query 432, and, adjacent to the query 432, can insert a third tag 434 (e.g., {{QUERYSTRING}}), which can be associated with a third variable that can represent or relate to a query response value with regard to a rule being generated. The query key element 436 can be associated with query key-related information 438 (e.g., query keywords), such as, in this example, “system” and “severity,” which can be utilized to facilitate obtaining responses to the query 424 and query 432, respectively, to facilitate replacing the respective tags, second tag 426 and third tag 434, with respective items of data, from the data file, that can correspond to or be responsive to the respective queries, query 424 and query 432. It is noted that, in different rule templates, the number and/or type of tags can be different (or the same). It also is noted that, in another rule template, the query key-related information can (or may not) be different.

Further, based at least in part on the rule format parameters, tags, and group of rule elements, at a sixth subset of locations in the rule template 400, the template generator component 204 can insert a payload element 440 (e.g., http_post_payload) that can comprise various items of payload information 442, including, for example, the name of the node (e.g., nodename: system) to which the payload information is to be communicated, the condition, type of event, or severity level (e.g., severity: severity) associated with the event, a message, a timestamp (e.g., timestamp: “@timestamp”) that can indicate the time of the event or the message, an alarm name (e.g., alarmname: name) that can indicate the name or type of alarm, a date associated with the application, or other desired payload information. It is noted that, in another rule template, the payload information can (or may not) be different.

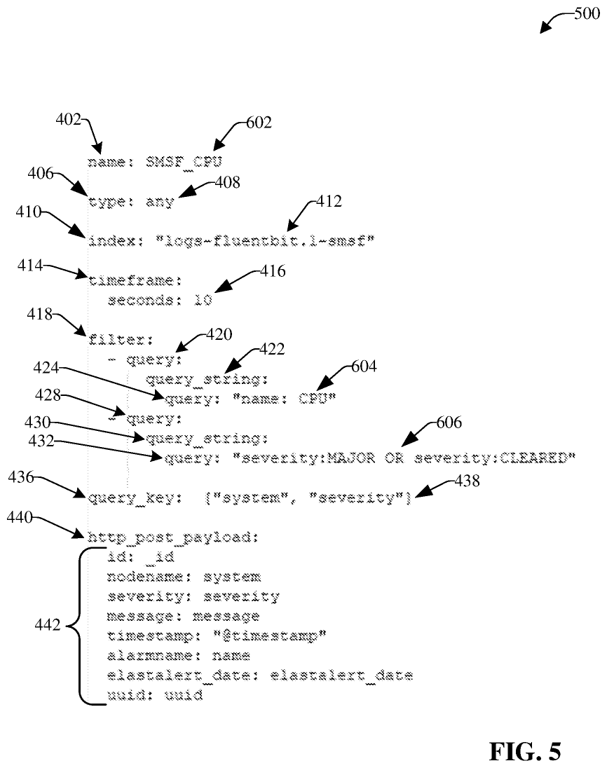

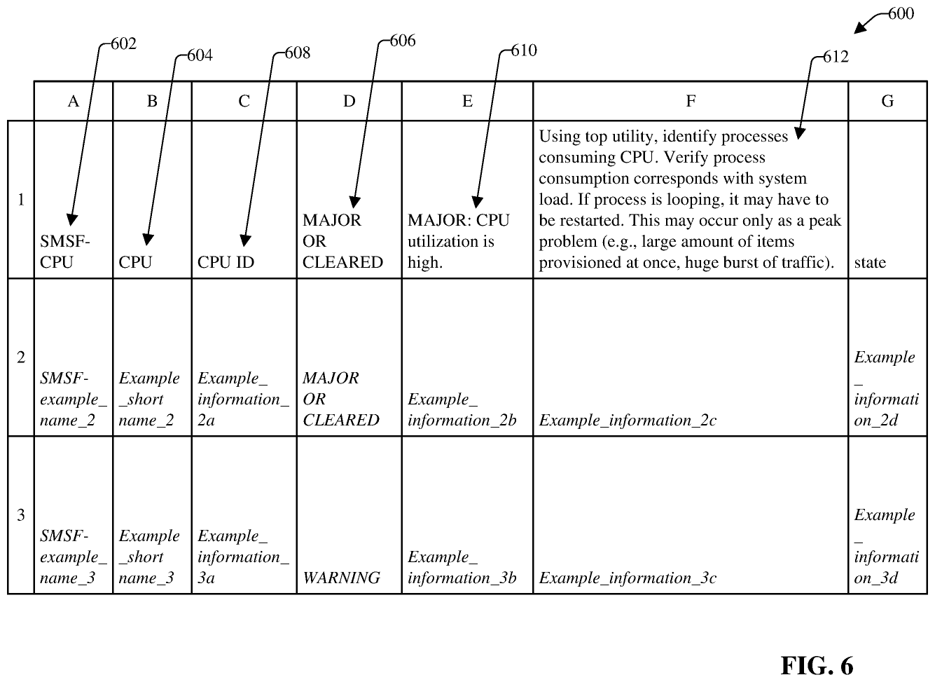

Turning to FIGS. 5 and 6 (along with FIGS. 1-4), FIG. 5 depicts a diagram of an example, non-limiting rule 500 that can be determined and generated based at least in part on the rule template (e.g., rule template 400) and data obtained from a data file (e.g., a vendor provided, network function-specific data file), for use with a desired application, and FIG. 6 presents a diagram of a portion of the data file 600 (e.g., an example data file), in accordance with various aspects and embodiments of the disclosed subject matter. The rule generator component 208 can determine and generate (e.g., automatically determine and generate) a group of rules, comprising the rule 500, based at least in part on the rule template and items of data obtained from the data file 600 and merged with the rule template 400.

The rule 500, as generated by the rule generator component 208, can comprise the various rule elements and associated non-tag information of the rule template 400. For instance, the rule 500 can comprise the name element 402, type element 406, type-related information 408, index element 410, index-related information 412, timeframe element 414, time frame-related information 416, filter element 418, query element 420, query string 422, query 424, query element 428, query string 430, query 432, query key element 436, query key-related information 438, payload element 440, and payload information 442.

As part of determining and generating the rule 500, the rule generator component 208 can identify the first tag 404 (e.g., {{RULENAME}}) in the rule template based at least in part on the tag indicator (e.g., brace-brace on each end of the first tag 404) and also can identify, based at least in part on the first tag 404 overall or the first tag name (e.g., RULENAME), the type of tag the first tag 404 is and/or the type of information that is to be inserted into the location in the rule 500 that corresponds to the location of the first tag 404 in the rule template 400 (e.g., adjacent to the name element 402). The rule generator component 208 can determine the item of data in the data file 600 that corresponds to the first tag 404. For instance, the rule generator component 208 can determine that the first item of data 602, which, in this example, can be “SMSF-CPU,” can be associated with or mapped to the first tag 404, based at least in part on the results of an analysis of the rule template 400 and the data file 600 (e.g., the appropriate row and column (e.g., first row and first column (A)) in the data file 600), and/or a mapping between the respective tags (e.g., 404, 426, and 434) of the rule template 400 and the respective items of data (and/or the respective data portions (e.g., columns) in the data file 600 (e.g., as determined and generated by the tag component 206). As part of generating the rule 500, the rule generator component 208 can replace the first tag 404 in the rule template 400 with the first item of data 602 (e.g., SMSF-CPU) of the rule 500 (e.g., the rule generator component 208 can substitute the first item of data 602 for the first tag 404 in the rule template 400 as part of generating the rule 500).

The rule generator component 208 also can identify the second tag 426 (e.g., {{SHORTRULENAME}}) in the rule template based at least in part on the tag indicator and also can identify, based at least in part on the second tag 426 overall or the second tag name (e.g., SHORTRULENAME), the type of tag the second tag 426 is and/or the type of information that is to be inserted into the location in the rule 500 that corresponds to the location of the second tag 426 in the rule template 400 (e.g., adjacent to the query 424 (e.g., “query: name:”)). The rule generator component 208 can determine the item of data in the data file 600 that corresponds to the second tag 426. For example, the rule generator component 208 can determine that the second item of data 604, which, in this example, can be “CPU,” can be associated with or mapped to the second tag 426, based at least in part on the results of an analysis of the rule template 400 and the data file 600 (e.g., the appropriate row and column (e.g., first row and second column (B)) in the data file 600), and/or a mapping between the respective tags of the rule template 400 and the respective items of data (and/or the respective data portions (e.g., columns) in the data file 600 (e.g., as determined and generated by the tag component 206). As part of generating the rule 500, the rule generator component 208 can replace the second tag 426 in the rule template 400 with the second item of data 604 (e.g., “CPU”) of the rule 500.

The rule generator component 208 also can identify the third tag 434 (e.g., {{QUERYSTRING}}) in the rule template based at least in part on the tag indicator and also can identify, based at least in part on the third tag 434 overall or the third tag name (e.g., QUERYSTRING), the type of tag the third tag 434 is and/or the type of information that is to be inserted into the location in the rule 500 that corresponds to the location of the third tag 434 in the rule template 400 (e.g., adjacent to the query 432 (e.g., “query:”). The rule generator component 208 can determine the item of data in the data file 600 that corresponds to the third tag 434. For instance, the rule generator component 208 can determine that the third item of data 606, which, in this example, can be “MAJOR OR CLEARED,” can be associated with or mapped to the third tag 434, based at least in part on the results of an analysis of the rule template 400 and the data file 600 (e.g., the appropriate row and column (e.g., first row and fourth column (D)) in the data file 600), and/or a mapping between the respective tags of the rule template 400 and the respective items of data (and/or the respective data portions (e.g., columns) in the data file 600 (e.g., as determined and generated by the tag component 206). As part of generating the rule 500, the rule generator component 208 can replace the third tag 434 in the rule template 400 with the third item of data 606 (e.g., “MAJOR OR CLEARED”) of the rule 500 (e.g., query: “severity: MAJOR OR severity: CLEARED”).

The data file 600 also can include other items of data. In the example data file 600, the other items of data can comprise a fourth item of data 608, which in this example can be “CPU ID,” a fifth item of data 610, which in this example can be “MAJOR: CPU utilization is high,” a sixth item of data 612, which in this example can be a suggestion or instruction of how to rectify the major event of the CPU utilization being high, and/or other items of data. The data file 600 also can include one or more other rows of items of data (not shown in FIG. 6) that can be utilized by the rule generator component 208 to generate one or more other rules using the rule template 400.

In some instances, creating rules for a network function can involve multiple rule templates. In some embodiments, the RGMC 102, employing the rule generator component 208, can comprise logic and functionality that can enable the rule generator component 208 to recognize which rule template of the multiple templates to use for a particular rule, identify the tags in that rule template, and know which items of data in the data file are to be used to replace the tags (e.g., via a mapping and/or relationships between the tags and items of data), and the rule generator component 208 can determine and generate the particular rule, for each of the respective rules to be generated using the respective templates associated with the network function. In certain embodiments, alternatively or additionally, the RGMC 102, can facilitate generating or instantiating different instances of the RGMC 102 with each instance of the RGMC 102 having different logic and functionality that can be desirable (e.g., suitable, appropriate, or optimal) for use in generating respective subsets of rules associated with the network function using the respective rule templates associated with the network function.

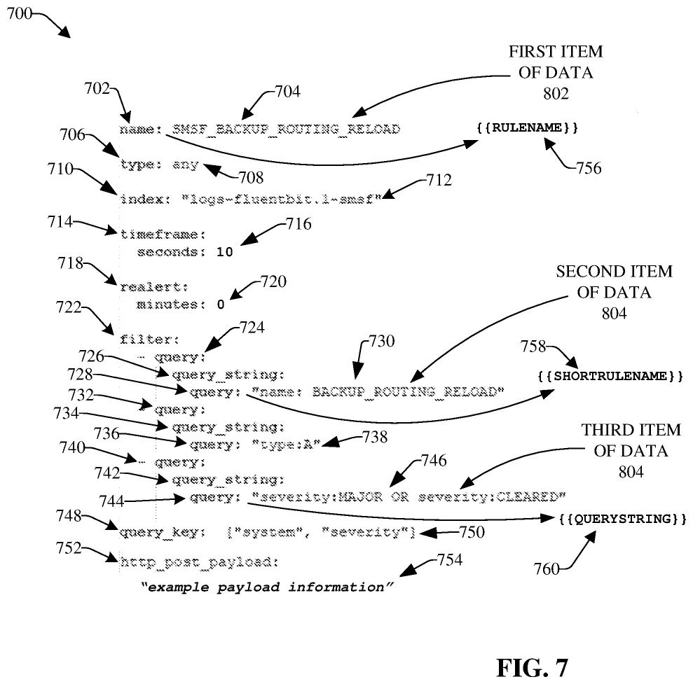

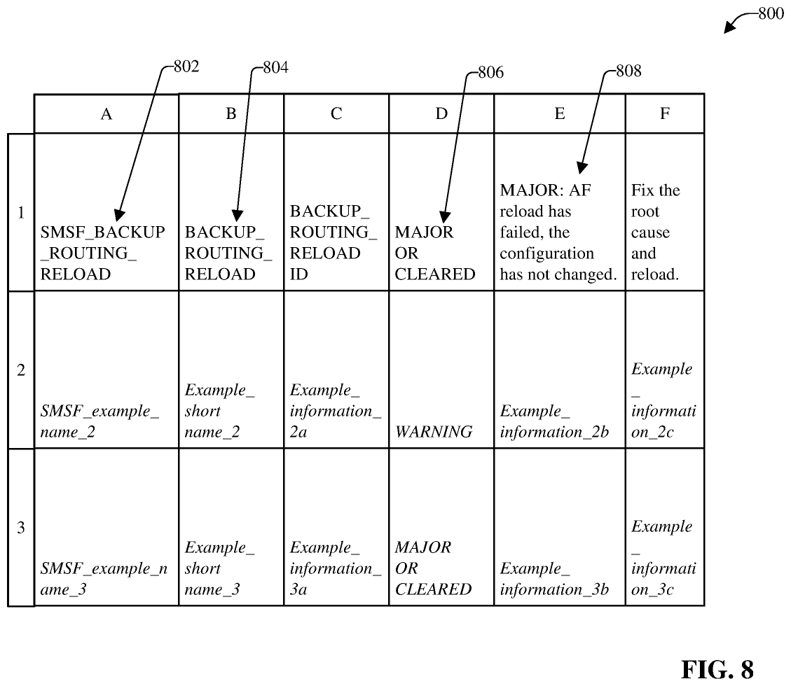

Turning to FIGS. 7 and 8 (along with FIGS. 1-3), FIG. 7 depicts a diagram of another example, non-limiting rule 700 that can be determined and generated based at least in part on a rule template and data obtained from a data file (e.g., a vendor provided, network function-specific data file), for use with a desired application, and FIG. 8 presents a diagram of a portion of the data file 800 (e.g., another example data file), in accordance with various aspects and embodiments of the disclosed subject matter. The rule generator component 208 can determine and generate (e.g., automatically determine and generate) a group of rules, comprising the rule 700, based at least in part on the rule template and items of data obtained from the data file 800 and merged with the rule template. The rule template employed to facilitate generating the rule 700 is similar to the rule template 400 of FIG. 4, and can comprise many of the same rule elements as the rule template 400, but, as can be observed, does have some different rule elements than the rule template 400.

The rule 700, as generated by the rule generator component 208, can comprise the various rule elements and associated non-tag information of the rule template from which the rule was generated, such as described herein. For instance, the rule 700 can comprise a name element 702, name-related information 704 (e.g., “SMSF_BACKUP_ROUTING_RELOAD”), type element 706, type-related information 708 (e.g., “any”), index element 710, index-related information 712 (e.g., “logs-fluentbit.1-smsf”), timeframe element 714, time frame-related information 716 (e.g., “10” representing 10 seconds), realert element 718, realert-related information 720 (e.g., “0” representing 0 minutes), filter element 722, query element 724, query string 726, query 728, query-related information 730 (e.g., “name: BACKUP_ROUTING_RELOAD”), query element 732, query string 734, query 736, query-related information 738 (e.g., “type:A”), query element 740, query string 742, query 744, query-related information 746 (e.g., “severity: MAJOR OR severity: CLEARED”), query key element 748, query key-related information 750 (e.g., [“system”, “severity”]), payload element 752 (e.g., “http_post_payload”), and payload information 754 (e.g., “example payload information”).

It is noted that, as compared to the rule template 400 of FIG. 4, the rule template utilized to generate the rule 700 of FIG. 7 included, for example, a realert element 718 and associated realert-related information 720, and included an additional query element and associated query string and query (e.g., query element 732, query string 734, query 736, query-related information 738 (e.g., “type:A”)). With regard to the realert element 718 and the associated realert-related information 720, which, in this example, is “0,” the 0 value can indicate the amount of time (e.g., 0 minutes) that the application 106 is to wait before generating and presenting (e.g., communicating or displaying) a realert signal to realert or notify regarding an event or condition. It is noted that, in another rule template, the realert-related information can (or may not) be different (e.g., an amount of time greater than 0 minutes can be utilized, as desired by a user).

It also is noted that, as part of the generation of the rule 700, the rule generator component 208 replaced three tags in the rule template with three corresponding items of data that the rule generator component 208 obtained or retrieved from the portion of the data file 800 of FIG. 8. For instance, the rule template can include a first tag 756 (e.g., {{RULENAME}}), second tag 758 (e.g., {{SHORTRULENAME}}), and third tag 760 (e.g., {{QUERYSTRING}}), which respectively can be representative of a first variable (e.g., first parameter), a second variable, and a third variable.

As part of determining and generating the rule 700, the rule generator component 208 can identify the first tag 756 (e.g., {{RULENAME} }) in the rule template based at least in part on the tag indicator (e.g., brace-brace on each end of the first tag 756) and also can identify, based at least in part on the first tag 756 overall or the first tag name (e.g., RULENAME), the type of tag the first tag 756 is and/or the type of information that is to be inserted into the location in the rule 700 that corresponds to the location of the first tag 756 in the rule template (e.g., adjacent to the name element 702). The rule generator component 208 can determine the item of data in the data file 800 that corresponds to the first tag 756. For instance, the rule generator component 208 can determine that the first item of data 802, which, in this example, can be “SMSF_BACKUP_ROUTING_RELOAD,” can be associated with or mapped to the first tag 756, based at least in part on the results of an analysis of the rule template and the data file 800 (e.g., the appropriate row and column (e.g., first row and first column (A)) in the data file 800), and/or a mapping between the respective tags (e.g., 756, 758, and 760) of the rule template and the respective items of data (and/or the respective data portions (e.g., columns) in the data file 800 (e.g., as determined and generated by the tag component 206). As part of generating the rule 700, the rule generator component 208 can replace the first tag 756 in the rule template with the first item of data 802 (e.g., SMSF_BACKUP_ROUTING_RELOAD) as the name-related information 704 of the rule 700.

The rule generator component 208 also can identify the second tag 758 (e.g., {{SHORTRULENAME}}) in the rule template based at least in part on the tag indicator and also can identify, based at least in part on the second tag 758 overall or the second tag name (e.g., SHORTRULENAME), the type of tag the second tag 758 is and/or the type of information that is to be inserted into the location in the rule 700 that corresponds to the location of the second tag 758 in the rule template (e.g., adjacent to the query 728 (e.g., “query: name:”)). The rule generator component 208 can determine the item of data in the data file 800 that corresponds to the second tag 758. For example, the rule generator component 208 can determine that the second item of data 804, which, in this example, can be “BACKUP_ROUTING_RELOAD,” can be associated with or mapped to the second tag 758, based at least in part on the results of an analysis of the rule template and the data file 800 (e.g., the appropriate row and column (e.g., first row and second column (B)) in the data file 800), and/or a mapping between the respective tags of the rule template and the respective items of data (and/or the respective data portions (e.g., columns) in the data file 800 (e.g., as determined and generated by the tag component 206). As part of generating the rule 700, the rule generator component 208 can replace the second tag 758 in the rule template with the second item of data 804 (e.g., “BACKUP_ROUTING_RELOAD”) as the query-related information 730 (e.g., “name: BACKUP_ROUTING_RELOAD”) of the rule 700.

The rule generator component 208 also can identify the third tag 760 (e.g., {{QUERYSTRING}}) in the rule template based at least in part on the tag indicator and also can identify, based at least in part on the third tag 760 overall or the third tag name (e.g., QUERYSTRING), the type of tag the third tag 760 is and/or the type of information that is to be inserted into the location in the rule 700 that corresponds to the location of the third tag 760 in the rule template (e.g., adjacent to the query 744). The rule generator component 208 can determine the item of data in the data file 800 that corresponds to the third tag 760. For example, the rule generator component 208 can determine that the third item of data 806, which, in this example, can be “MAJOR OR CLEARED,” can be associated with or mapped to the third tag 760, based at least in part on the results of an analysis of the rule template and the data file 800 (e.g., the appropriate row and column (e.g., first row and fourth column (D)) in the data file 800), and/or a mapping between the respective tags of the rule template and the respective items of data (and/or the respective data portions (e.g., columns) in the data file 800 (e.g., as determined and generated by the tag component 206). As part of generating the rule 700, the rule generator component 208 can replace the third tag 760 in the rule template with the third item of data 806 (e.g., “MAJOR OR CLEARED”) as the query-related information 746 of the rule 700 (e.g., query: “severity: MAJOR OR severity: CLEARED”).

The data file 800 also can include other items of data. In the example data file 800, the other items of data can comprise a fourth item of data 808, which in this example can be an explanation of the major event (e.g., “MAJOR: AF reload has failed, the configuration has not changed.”), and/or other items of data (e.g., suggestion or instruction for remedying or mitigating the major event). The data file 800 also can include one or more other rows of items of data that can be utilized by the rule generator component 208 to generate one or more other rules using the rule template.

With further regard to FIGS. 1 and 2, in some embodiments, the RGMC 102 can comprise an operations manager component 210 that can control (e.g., manage) operations associated with the RGMC 102. For example, the operations manager component 210 can facilitate generating instructions to have components (e.g., communicator component 202, template generator component 204, tag component 206, rule generator component 208, processor component 212, and/or data store 214) of or associated with the RGMC 102 perform operations, and can communicate respective instructions to such respective components of or associated with the RGMC 102 to facilitate performance of operations by the respective components of or associated with the RGMC 102 based at least in part on the instructions, in accordance with the defined rule generation management criteria and the defined rule generation management algorithm(s) (e.g., rule template generation algorithms, rule generation algorithms, tagging and/or mapping algorithms, and/or AI, machine learning, or neural network algorithms, as disclosed, defined, recited, or indicated herein by the methods, systems, and techniques described herein). The operations manager component 210 also can facilitate controlling data flow between the respective components of the RGMC 102 and controlling data flow between the RGMC 102 and another component(s) or device(s) (e.g., devices or components, such as a communication device, a network device, or other component or device) associated with (e.g., connected to) the RGMC 102.

The RGMC 102 also can comprise a processor component 212 that can work in conjunction with the other components (e.g., communicator component 202, template generator component 204, tag component 206, rule generator component 208, operations manager component 210, and/or data store 214) to facilitate performing the various functions of the RGMC 102. The processor component 212 can employ one or more processors, microprocessors, or controllers that can process data, such as information relating to data files, network functions or elements, rule template parameters, rule elements, rule templates, rules, tags, tables, spreadsheets, electronic textual documents, tag and data item relationship identification, mapping of tags to data items, variables, parameters, applications, metadata, codes, textual strings, communication devices, policies and rules, users, services, defined rule generation management criteria, traffic flows, signaling, algorithms (e.g., rule template generation algorithms, rule generation algorithms, tagging and/or mapping algorithms, and/or AI, machine learning, or neural network algorithms), protocols, interfaces, tools, and/or other information, to facilitate operation of the RGMC 102, as more fully disclosed herein, and control data flow between the RGMC 102 and other components (e.g., network components of or associated with the communication network, communication devices, or rule generation management components) and/or associated applications associated with the RGMC 102.

With further regard to the data store 214, the data store 214 can store data structures (e.g., user data, metadata), code structure(s) (e.g., modules, objects, hashes, classes, procedures) or instructions, information relating to data files, network functions or elements, rule template parameters, rule elements, rule templates, rules, tags, tables, spreadsheets, electronic textual documents, tag and data item relationship identification, mapping of tags to data items, variables, parameters, applications, metadata, codes, textual strings, communication devices, policies and rules, users, services, defined rule generation management criteria, traffic flows, signaling, algorithms (e.g., rule template generation algorithms, rule generation algorithms, tagging and/or mapping algorithms, and/or AI, machine learning, or neural network algorithms), protocols, interfaces, tools, and/or other information, to facilitate controlling operations associated with the RGMC 102. In an aspect, the processor component 212 can be functionally coupled (e.g., through a memory bus) to the data store 214 in order to store and retrieve information desired to operate and/or confer functionality, at least in part, to the RGMC 102 and its components, and the data store 214, and/or substantially any other operational aspects of the RGMC 102.

It should be appreciated that the data store 214 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

In some embodiments, the RGMC 102 can employ artificial intelligence (AI) and/or machine learning (ML) techniques, functions, and/or algorithms to perform analysis on data relating to rule format parameters, rule elements, rule templates, rules, tags, data items in data files, applications, users, metadata, historical information relating thereto, or other desired types of information, to facilitate determining or generating rule templates, identifying tags in rule templates, determining or generating rules, determining relationships between tags and data items in a data file, determining a mapping between tags and data items in a data file, replacing tags in a rule template with data items from a data file, and/or other determinations.

In some embodiments, in connection with or as part of such an AI or ML-based analysis, the RGMC 102 can employ, build (e.g., construct or create), and/or import, AI and/or ML techniques, functions, and algorithms, AI and/or ML models, neural networks (e.g., neural networks trained using the RGMC 102), and/or graph mining to render and/or generate predictions, inferences, calculations, prognostications, estimates, derivations, forecasts, detections, and/or computations that can facilitate determining or generating rule templates, identifying tags in rule templates, determining or generating rules, determining relationships between tags and data items in a data file, determining a mapping between tags and data items in a data file, replacing tags in a rule template with data items from a data file, and/or facilitate making other desired determinations, such as the determinations described herein, and/or facilitating automating one or more functions or features of the disclosed subject matter (e.g., automating one or more functions or features of or associated with the RGMC 102, the communication network 104, a communication device, or other device or component), as more fully described herein.

The RGMC 102 can employ various AI-based or ML-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the RGMC 102 can examine the entirety or a subset of the data (e.g., data associated with data sessions, communication devices, or users; or other data) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the disclosed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In accordance with various embodiments, the disclosed subject matter, employing the RGMC 102 and its constituent or associated components, and/or associated applications, can perform multiple (e.g., two or more) operations relating to data analysis, rule template generation, rule generation analysis, rule generation, determining relationships between tags and data items, mapping tags to data items, and/or determining and generating tags, in parallel, concurrently, and/or simultaneously, as desired.

The systems and/or devices have been (or will be) described herein with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

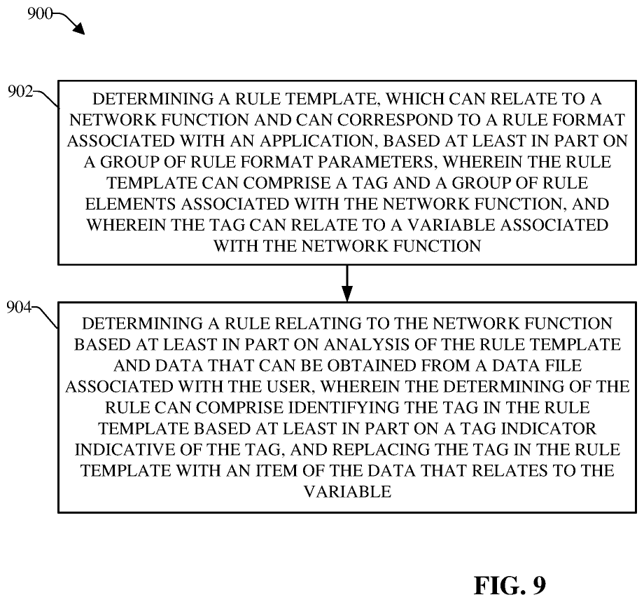

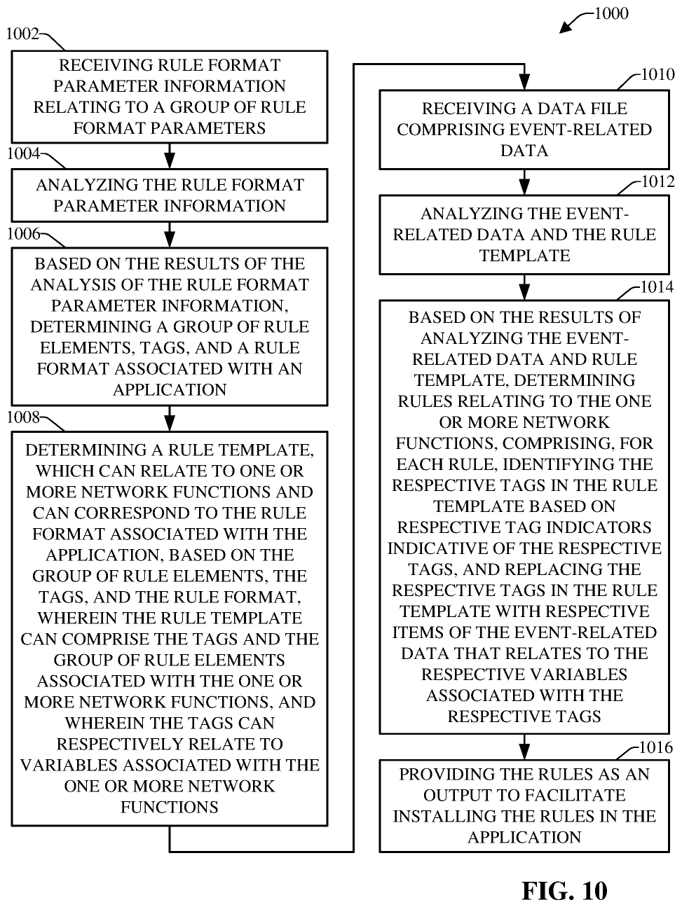

In view of the example systems and/or devices described herein, example methods that can be implemented in accordance with the disclosed subject matter can be further appreciated with reference to flowchart in FIGS. 9-10. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 9 illustrates a flow diagram of an example, non-limiting method 900 that can desirably (e.g., automatically, accurately, efficiently, and/or optimally) determine rule templates and rules associated with network functions, in accordance with various aspects and embodiments of the disclosed subject matter. The method 900 can be implemented by a system that can comprise a RGMC, a processor component, a data store, and/or another component(s), wherein the RGMC can comprise a template generator component and a rule generator component. Alternatively, or additionally, a machine-readable medium can comprise executable instructions that, when executed by a processor, facilitate performance of the operations of the method 900.

At 902, a rule template, which can relate to a network function and can correspond to a rule format associated with an application, can be determined based at least in part on a group of rule format parameters, wherein the rule template can comprise a tag and a group of rule elements associated with the network function, and wherein the tag can relate to a variable associated with the network function. For each network function, the template generator component can receive information relating to the group of rule format parameters from a user, the application, and/or another data source, such as described herein. With regard to each network function, the template generator component can determine and generate the rule template, which can relate to the network function and can correspond to the rule format associated with the application, based at least in part on the group of rule format parameters. With regard to each network function, the rule template can comprise one or more tags, and the group of rule elements, associated with the network function, wherein each tag of the one or more tags can relate to a variable associated with the network function.

At 904, a rule relating to the network function can be determined based at least in part on analysis of the rule template and data that can be obtained from a data file associated with the user, wherein the determining of the rule can comprise identifying the tag in the rule template based at least in part on a tag indicator indicative of the tag, and replacing the tag in the rule template with an item of the data that relates to the variable. For instance, with regard to each desired event of a group of events associated with the network function, the rule generator component can determine and generate a rule, which can relate to the network function, based at least in part on the analysis of the rule template and the data, which can be received or obtained from the data file associated with the user. As part of the determining and generating of the rule, the rule generator component can identify the tag in the rule template based at least in part on the tag indicator indicative of the tag, and can replace the tag in the rule template with the item of the data that can relate to the variable.

FIG. 10 depicts a flow diagram of another example, non-limiting method 1000 that can desirably (e.g., automatically, accurately, efficiently, and/or optimally) determine rule templates and rules associated with network functions, in accordance with various aspects and embodiments of the disclosed subject matter. The method 1000 can be implemented by a system that can comprise a RGMC, a processor component, a data store, and/or another component(s), wherein the RGMC can comprise a template generator component and a rule generator component. Alternatively, or additionally, a machine-readable medium can comprise executable instructions that, when executed by a processor, facilitate performance of the operations of the method 1000.

At 1002, rule format parameter information relating to a group of rule format parameters can be received. At 1004, the rule format parameter information can be analyzed. The template generator component can receive the rule format parameter information relating to the group of rule format parameters from a user (e.g., communication network provider, operator, developer, engineer, or technician; vendor; or other user) and/or an application (e.g., ElastAlert or other application). The template generator component can analyze the rule format parameter information to facilitate determining the rule format for the rules, rule elements of the rules, and determining the variables associated with the rules.

At 1006, based at least in part on the results of the analysis of the rule format parameter information, a group of rule elements, tags, and a rule format associated with an application can be determined. At 1008, a rule template, which can relate to one or more network functions and can correspond to the rule format associated with the application, can be determined based at least in part on the group of rule elements, the tags, and the rule format, wherein the rule template can comprise the tags and the group of rule elements associated with the one or more network functions, and wherein the tags can respectively relate to variables associated with the one or more network functions. Based at least in part on the results of the analysis of the rule format parameter information, the template generator component can determine the group of rule elements, the tags, and the rule format associated with the application. Based at least in part on the group of rule elements, the tags, and the rule format, the template generator component can determine and generate the rule template, which can relate to the one or more network functions and can correspond to the rule format associated with the application. The rule template can comprise the tags and the group of rule elements associated with the one or more network functions. The template generator component can arrange the tags and rule elements, and information associated with the rule elements, in the rule template in accordance with the rule format. The rule format can be specified or dictated by the user and/or the application (e.g., via the rule format parameter information).

At 1010, a data file comprising event-related data can be received. At 1012, the event-related data and the rule template can be analyzed. The RGMC can receive the data file from a user (e.g., vendor or other user) directly (e.g., via an interface of the RGMC) or via a communication device. The data file can comprise event-related data that can relate to events, network components, systems and/or subsystems of or associated with the communication network, actions to be taken in response to events, and/or other desired information. The rule generator component can analyze the event-related information.

At 1014, based at least in part on the results of analyzing the event-related data and the rule template, rules relating to the one or more network functions can be determined, wherein the determining of the rules can comprise, for each rule, identifying the respective tags in the rule template based at least in part on respective tag indicators indicative of the respective tags, and replacing the respective tags in the rule template with respective items of the event-related data that relates to the respective variables associated with the respective tags. For instance, based at least in part on the results of the event-related data and the rule template, the rule generator component can determine and generate the rules relating to the one or more network functions. As part of determining and generating the rules, the rule generator component can, for each rule, identify the respective tags in the rule template based at least in part on the respective tag indicators indicative of the respective tags that are associated with the respective variables, and can replace the respective tags in the rule template with the respective items of the event-related data that relate to the respective variables, such as described herein.

At 1016, the rules can be provided as an output to facilitate installing the rules in the application. The RGMC can provide the rules as an output to facilitate installing the rules in the application.

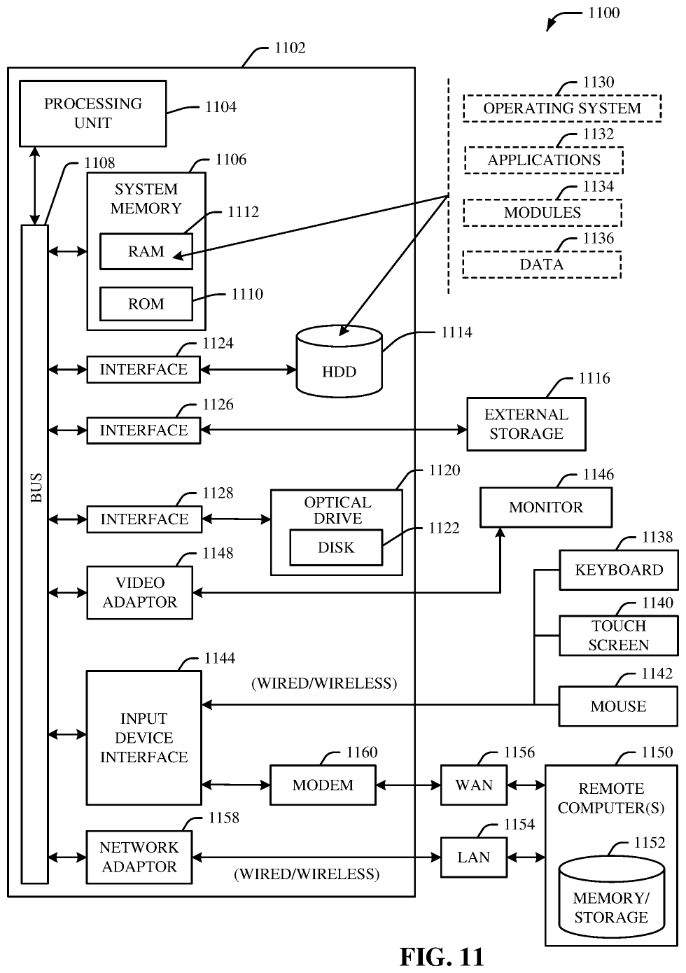

In order to provide additional context for various embodiments described herein, FIG. 11 and the following discussion are intended to provide a brief, general description of a suitable computing environment 1100 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156, e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like can refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “entity,” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

Systems, methods and/or machine-readable storage media for facilitating a two-stage downlink control channel for 5G systems are provided herein. Legacy wireless systems such as LTE, Long-Term Evolution Advanced (LTE-A), High Speed Packet Access (HSPA) etc. use fixed modulation format for downlink control channels. Fixed modulation format implies that the downlink control channel format is always encoded with a single type of modulation (e.g., quadrature phase shift keying (QPSK)) and has a fixed code rate. Moreover, the forward error correction (FEC) encoder uses a single, fixed mother code rate of ⅓ with rate matching. This design does not take into the account channel statistics. For example, if the channel from the BS device to the mobile device is very good, the control channel cannot use this information to adjust the modulation, code rate, thereby unnecessarily allocating power on the control channel. Similarly, if the channel from the BS to the mobile device is poor, then there is a probability that the mobile device might not be able to decode the information received with only the fixed modulation and code rate. As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can comprise, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise analyzing data, determining and/or generating a rule template, determining relationships between tags and data items of a data file, determining and/or generating tags, determining and/or generating rules using rule templates, or other actions. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, the RGMC, communication devices, processors, data stores, AI component, sensors, antennae, audio and/or visual output devices, or other devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
determining, by a system comprising a processor, a rule template that relates to a network function and corresponds to a rule format associated with an application, wherein the rule template comprises a tag and a group of rule elements associated with the network function, and wherein the tag relates to a variable associated with the network function; and
determining, by the system, a rule relating to the network function based on analysis of the rule template and data that is obtained from a data file associated with a user identity, wherein the determining of the rule comprises identifying the tag in the rule template based on a tag indicator indicative of the tag, and replacing the tag in the rule template with an item of the data that relates to the variable.

2. The method of claim 1, wherein the item of the data is a first item of the data, wherein the rule is a first rule, and wherein the method further comprises:
determining, by the system, a second rule relating to the network function based on the analysis of the rule template and the data, wherein the determining of the second rule comprises, identifying the tag in the rule template based on the tag indicator indicative of the tag, and replacing the tag in the rule template with a second item of the data that relates to the variable.

3. The method of claim 2, further comprising:
installing, by the system, a group of rules, comprising the first rule and the second rule, in the application.

4. The method of claim 1, wherein the tag is a first tag, wherein the variable is a first variable, wherein the tag indicator is a first tag indicator, wherein the rule template comprises the first tag, a second tag, and the group of rule elements associated with the network function, wherein the second tag relates to a second variable associated with the network function, wherein the item of the data is a first item of the data, and
wherein the determining of the rule comprises identifying the second tag in the rule template based on a second tag indicator indicative of the second tag, and replacing the second tag in the rule template with a second item of the data that relates to the second variable.

5. The method of claim 1, wherein the rule template that relates to the network function is a first rule template that relates to a first network function, wherein the group of rule elements is a first group of rule elements, wherein the rule is a first rule, wherein the data obtained from the data file associated with the user identity is first data obtained from a first data file associated with a first user identity, wherein the tag is a first tag, wherein the variable is a first variable, wherein the item of the data is a first item of the data, and wherein the method further comprises:
determining, by the system, a second rule template that relates to a second network function and corresponds to the rule format associated with the application, wherein the second rule template comprises a second tag and a second group of rule elements associated with the second network function, and wherein the second tag relates to a second variable associated with the second network function; and
determining, by the system, a second rule relating to the second network function based on analysis of the second rule template and second data that is obtained from a second data file associated with the first user identity or a second user identity, wherein the determining of the second rule comprises identifying the second tag in the second rule template based on a second tag indicator indicative of the second tag, and replacing the second tag in the second rule template with a second item of the second data that relates to the second variable.

6. The method of claim 1, further comprising:
receiving, by the system, rule-related information that comprises the group of rule elements, wherein the group of rule elements comprises a network function name of the network function, a query element relating to a query to be performed using the rule, a name element relating to a component name of a component associated with the network function, a condition element relating to a condition associated with the component or the network function, a time element indicative of a time associated with the condition, or a payload element relating to payload information that is to be communicated to a node in response to the condition being determined to be satisfied.

7. The method of claim 1, wherein the tag is a first tag, wherein the variable is a first variable, wherein the item of the data is a first item of the data, and wherein the method further comprises:
receiving, by the system, the data file comprising the data, wherein the data comprises items of the data that are arranged in a structured format or an unstructured format in the data file, and wherein the items of the data comprise the first item of the data associated with the first variable and the first tag, a second item of the data associated with the first variable and the first tag, or a third item of the data associated with a second variable associated with the network function and a second tag associated with the second variable.

8. The method of claim 7, further comprising:
mapping, by the system, the first item of the data, the second item of the data, or a first portion of the data file to the first variable or the first tag, wherein the first portion of the data file comprises the first item of the data or the second item of the data; and
mapping, by the system, the third item of the data or a second portion of the data file to the second variable or the second tag, wherein the second portion of the data file comprises the third item of the data.

9. The method of claim 1, further comprising:
receiving, by the system, an updated data file associated with the network function and the user identity, wherein the updated data file comprises updated data that is different from the data;
analyzing, by the system, the rule template and the updated data of the updated data file; and
based on the analyzing of the rule template and the updated data, determining, by the system, an updated rule relating to the network function, wherein the updated rule is different from the rule, and wherein the determining of the updated rule comprises identifying the tag in the rule template based on the tag indicator indicative of the tag, and replacing the tag in the rule template with an updated item of the updated data that relates to the variable.

10. The method of claim 1, further comprising:
receiving, by the system, an updated group of rule elements associated with the network function, wherein the updated group of rule elements is different from the group of rule elements; and
determining, by the system, an updated rule template that relates to the network function and corresponds to the rule format associated with the application, wherein the updated rule template is different from the rule template, wherein the updated rule template comprises an updated group of elements, the tag, or an updated tag associated with the network function, and wherein the tag relates to the variable, or the updated tag relates to the variable or an updated variable associated with the network function.

11. The method of claim 10, further comprising:
one of:
determining, by the system, a first updated rule that relates to the network function based on analysis of the updated rule template and the data of the data file, wherein the determining of the first updated rule comprises identifying the tag in the updated rule template based on the tag indicator indicative of the tag, and replacing the tag in the updated rule template with the item of the data that relates to the variable;
determining, by the system, a second updated rule that relates to the network function based on analysis of the updated rule template and the data of the data file, wherein the determining of the second updated rule comprises identifying the updated tag in the updated rule template based on an updated tag indicator indicative of the updated tag, and replacing the updated tag in the updated rule template with the item of the data that relates to the variable or the updated variable; or
receiving, by the system, an updated data file associated with the network function, wherein the updated data file comprises updated data that is different from the data, and
determining, by the system, a third updated rule that relates to the network function based on analysis of the updated rule template and the updated data of the updated data file, wherein the determining of the third updated rule comprises identifying the tag or the updated tag in the updated rule template based on the tag indicator indicative of the tag or the updated tag indicator indicative of the updated tag, and replacing the tag or the updated tag in the updated rule template with an updated item of the updated data that relates to the variable or the updated variable.

12. The method of claim 1, wherein the tag is in a defined tag format that facilitates identification of the tag in the rule template and distinguishing the tag from the group of rule elements in the rule template, and wherein the tag comprises the tag indicator that is indicative of the tag and a tag name that indicates the variable to which the tag pertains.

13. A system, comprising:
a processor; and
a memory that stores executable instructions that, when executed by the processor, facilitate performance of operations, comprising:
generating a rule template that is associated with a network function and corresponds to a rule format associated with an application, wherein the rule template comprises a tag and rule-related information, and wherein the tag relates to a parameter associated with the network function; and
determining a rule associated with the network function based on analysis of the rule template and data received from a data file associated with a user identity, wherein the determining of the rule comprises identifying the tag in the rule template based on a tag marker indicative of the tag, and substituting an item of the data relating to the parameter for the tag in the rule template.

14. The system of claim 13, wherein the operations further comprise:
determining a group of rules, comprising the rule, associated with the network function based on the analysis of the data and the rule template; and
installing the group of rules in the application.

15. The system of claim 13, wherein the item of the data is a first item of the data, wherein the rule is a first rule, and wherein the operations further comprise:
determining a second rule associated with the network function based on the analysis of the rule template and the data, wherein the determining of the second rule comprises, identifying the tag in the rule template based on the tag marker indicative of the tag, and substituting a second item of the data relating to the parameter for the tag in the rule template.

16. The system of claim 13, wherein the tag is a first tag, wherein the parameter is a first parameter, wherein the tag marker is a first tag marker, wherein the rule template comprises the first tag, a second tag, and the group of rule elements associated with the network function, wherein the second tag relates to a second parameter associated with the network function, wherein the item of the data is a first item of the data, and
wherein the determining of the rule comprises identifying the second tag in the rule template based on a second tag marker indicative of the second tag, and substituting a second item of the data relating to the second parameter for the second tag in the rule template.

17. The system of claim 13, wherein the rule template associated with the network function is a first rule template associated with a first network function, wherein the group of rule elements is a first group of rule elements, wherein the rule is a first rule, wherein the data received from the data file associated with the user identity is first data received from a first data file associated with a first user identity, wherein the tag is a first tag, wherein the parameter is a first parameter, wherein the item of the data is a first item of the data, and wherein the operations further comprise:
determining a second rule template that is associated with a second network function and corresponds to the rule format associated with the application, wherein the second rule template comprises a second tag and a second group of rule elements associated with the second network function, and wherein the second tag relates to a second parameter associated with the second network function; and
determining a second rule associated with the second network function based on analysis of the second rule template and second data that is received from a second data file associated with the first user identity or a second user identity, wherein the determining of the second rule comprises identifying the second tag in the second rule template based on a second tag marker indicative of the second tag, and substituting a second item of the second data relating to the second parameter for the second tag in the second rule template.

18. The system of claim 13, wherein the tag is a first tag, wherein the parameter is a first parameter, wherein the item of the data is a first item of the data, and wherein the operations further comprise:
receiving the data file comprising the data, wherein the data comprises items of the data that are arranged in a structured format or an unstructured format in the data file, and wherein the items of the data comprise the first item of the data associated with the first parameter and the first tag, a second item of the data associated with the first parameter and the first tag, or a third item of the data associated with a second parameter associated with the network function and a second tag associated with the second parameter.

19. A non-transitory machine-readable medium, comprising executable instructions that, when executed by a processor, facilitate performance of operations, comprising:
creating a rule template that is associated with a network function and in accordance with a rule format associated with an application, wherein the rule template comprises a tag and a group of rule elements associated with the network function, and wherein the tag relates to a variable associated with the network function; and
creating a rule associated with the network function based on analysis of the rule template and data that is comprised in a data file, wherein the creating of the rule comprises identifying the tag in the rule template based on a tag indicator indicative of the tag, and replacing the tag in the rule template with an item of the data that relates to the variable.

20. The non-transitory machine-readable medium of claim 19, wherein the operations further comprise:
installing a group of rules, comprising the rule and associated with the network function, in the application.
